(19) United States
(12) Patent Application Publication
(10) Pub. No.: US 2023/0298250 A1
(43) Pub. Date: Sep. 21, 2023

(54) STEREOSCOPIC FEATURES IN VIRTUAL REALITY

(71) Applicant: Meta Platforms Technologies, LLC, Menlo Park, CA (US)

(72) Inventors: Ming Luo, San Carlos, CA (US); Goro Fujita, Santa Clara, CA (US)

(21) Appl. No.: 17/744,546

(22) Filed: May 13, 2022

Related U.S. Application Data
(60) Provisional application No. 63/320,501, filed on Mar. 16, 2022.

(51) Int. Cl. G06T 15/04; H04N 13/383; H04N 13/344; G06T 15/80

(52) U.S. Cl. CPC G06T 15/04; H04N 13/383; H04N 13/344; G06T 15/80

(57) ABSTRACT

Various aspects of the subject technology relate to systems, methods, and machine-readable media for stereoscopic features in a shared artificial reality environment. Various aspects may include creating a first camera object for rendering a first image of an area in the shared artificial reality environment at a first angle. Aspects may also include creating a second camera object for rendering a second image of the area at a second angle. Aspects may also include routing a combination of the first image and the second image for an optical viewpoint for a user representation in the shared artificial reality environment. Aspects may also include generating a stereoscopic texture based on the combination of the first image and the second image. Aspects may include applying, via a shader, the stereoscopic texture to a virtual element in the area.

### CROSS REFERENCE TO RELATED APPLICATION

The present disclosure is related to and claims priority under 35 USC § 1.119(e) to U.S. Provisional Patent Application No. 63/320,501, entitled STEREOSCOPIC TEXTURES, filed on Mar. 16, 2022, the content of which is incorporated herein by reference, in its entirety, and for all purposes.

### TECHNICAL FIELD

The present disclosure generally relates to three-dimensional (3D) effects in computer generated shared artificial reality environments, and more particularly to stereoscopic textures applied to virtual or artificial elements in such environments.

### BACKGROUND

Interaction in a computer generated shared artificial reality environment involves interaction with various types of artificial reality/virtual content, elements, and/or applications in the shared artificial reality environment. Users of the shared artificial reality environment may interact with two-dimensional (2D) as well as 3D virtual elements in the shared artificial reality environment. For example, user representations such as avatars may be rendered as 3D objects in the environment. There may be demanding performance caps associated with mobile and high fidelity rendering for such 3D objects, such as rendering in real time. It may be beneficial to adjust visual rendering so as to reduce the computer processing cost and time associated with providing 3D elements in the shared artificial reality environment.

### BRIEF SUMMARY

The subject disclosure provides for systems and methods for stereoscopic textures in a shared artificial reality environment (e.g., shared virtual reality environment). In particular, stereoscopic textures may be applied to two-dimensional objects to simulate an illusion of a three-dimensional effect. This advantageously achieves the advantages of 3D in the artificial reality environment without the computational and/or processing cost of rendering 3D geometries and objects in the environment. As used herein, stereoscopic textures can refer to generation of an image pair by a digital stereoscopic camera (e.g., computer graphics camera object) for feeding the image pair to each eye of users rendered in the environment as user representations. That is, the image pair may comprise a pair of different images (e.g., at different camera angles), such as with an offset, that are routed to an artificial/virtual reality headset to simulate a 3D effect for such depth perception of a human eye. In particular, the digital stereoscopic camera may render a 3D scene in the environment based on comprising two camera objects positioned side by side to mimic the process of stereo vision in a human brain. Advantageously, such stereoscopic textures can be generated and/or pre-rendered for surfaces in the artificial reality environment so that high fidelity imagery with the illusion of 3D depth (binocular disparity) can be achieved in a performance efficient manner.

The subject disclosure also may provide stereoscopic textures as “decals” for enabling 3D effects on flat surfaces in the environment. Such application of stereoscopic textures beneficially can efficiently and robustly increase visual fidelity by maintaining dimensionality through the illusion of depth without having to actually render true 3D objects. The stereoscopic textures may be applied to virtual screens, thumbnails, still images, decorations, user interfaces, portals (e.g., pre-rendered portals for closed VR worlds or real-time for open VR worlds), art, cards, windows, decals, posters, or covers, etc., such as via textures on otherwise 2D virtual elements. The stereoscopic textures of the subject disclosure can advantageously represent complex virtual scenes within the shared artificial reality environment in a computationally efficient manner without dense virtual 3D geometry. For example, users of the environment may perceive 2D virtual objects that have a stereoscopic texture applied as 3D when staring at or holding such objects. The further the distance between a textured surface of the 2D object with stereoscopic texture and a given user representation, the larger the binocular disparity perceived by the corresponding user.

According to one embodiment of the present disclosure, a computer-implemented method for stereoscopic features in a shared artificial reality environment is provided. The method includes creating a first camera object for rendering a first image of an area in the shared artificial reality environment at a first angle. The method also includes creating a second camera object for rendering a second image of the area at a second angle. The method also includes routing a combination of the first image and the second image for an optical viewpoint for a user representation in the shared artificial reality environment. The method also includes generating a stereoscopic texture based on the combination of the first image and the second image. The method also includes applying, via a shader, the stereoscopic texture to a virtual element in the area.

According to one embodiment of the present disclosure, a system is provided including a processor and a memory comprising instructions stored thereon, which when executed by the processor, causes the processor to perform a method for stereoscopic features in a shared artificial reality environment. The method includes creating a first camera object for rendering a first image of an area in the shared artificial reality environment at a first angle. The method also includes creating a second camera object for rendering a second image of the area at a second angle. The method also includes routing a combination of the first image and the second image for an optical viewpoint for a user representation in the shared artificial reality environment. The method also includes generating a stereoscopic texture based on the combination of the first image and the second image. The method also includes applying, via a shader, the stereoscopic texture to a virtual element in the area.

According to one embodiment of the present disclosure, a non-transitory computer-readable storage medium is provided including instructions (e.g., stored sequences of instructions) that, when executed by a processor, cause the processor to perform a method for stereoscopic features in a shared artificial reality environment. The method includes creating a first camera object for rendering a first image of an area in the shared artificial reality environment at a first angle. The method also includes creating a second camera object for rendering a second image of the area at a second angle. The method also includes routing a combination of the first image and the second image for an optical viewpoint for a user representation in the shared artificial reality environment. The method also includes generating a stereoscopic texture based on the combination of the first image and the second image. The method also includes applying, via a shader, the stereoscopic texture to a virtual element in the area.

According to one embodiment of the present disclosure, a non-transitory computer-readable storage medium is provided including instructions (e.g., stored sequences of instructions) that, when executed by a processor, cause the processor to perform a method for stereoscopic features in a shared artificial reality environment. The method includes creating a first camera object for rendering a first image of an area in the shared artificial reality environment at a first angle. The method also includes creating a second camera object for rendering a second image of the area at a second angle. The method also includes routing a combination of the first image and the second image for an optical viewpoint for a user representation in the shared artificial reality environment. The method also includes determining a zero parallax surface based on a first projection and a second projection of the optical viewpoint. The method also includes generating a stereoscopic texture based on the combination of the first image and the second image. The method also includes applying, via a shader, the stereoscopic texture to a virtual element in the area. The method also includes adjusting a value of the zero parallax surface for changing a type of three-dimensional effect for the virtual element.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram of a device operating environment with which aspects of the subject technology can be implemented.

FIGS. 2A-2B are diagrams illustrating virtual reality headsets, according to certain aspects of the present disclosure.

FIG. 2C illustrates controllers for interaction with an artificial reality environment, according to certain aspects of the present disclosure.

FIG. 3 is a block diagram illustrating an overview of an environment in which some implementations of the present technology can operate.

FIG. 4 illustrates an example artificial reality wearable, according to certain aspects of the present disclosure.

FIG. 5 is a block diagram illustrating an example computer system with which aspects of the subject technology can be implemented.

FIG. 6 is a block diagram illustrating an example stereoscopic camera system with which aspects of the subject technology can be implemented.

FIG. 7 is a block diagram illustrating an example stereoscopic texture, according to certain aspects of the present disclosure.

FIG. 8 is a block diagram illustrating an example stereoscopic texture in an example virtual scene of a shared artificial reality environment, according to certain aspects of the present disclosure.

FIG. 9 is an example flow diagram for stereoscopic features in a shared artificial reality environment, according to certain aspects of the present disclosure.

FIG. 10 is a block diagram illustrating an example computer system with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The disclosed system addresses a problem in artificial reality tied to computer technology, namely, the technical problem of the computational processing costs and efficiency of 3D objects within a computer generated shared artificial reality environment. The computer processing required for high fidelity 3D virtual objects, spaces, and/or elements may be significant and subject to latency. The disclosed system solves this technical problem by providing a solution also rooted in computer technology, namely, by providing stereoscopic textures for 3D depth or “thickness” so as to simulate 3D effect for still images or image sequences. For example, a given flat surface that represents a virtual user interface in the shared artificial reality environment can be perceived as comprising 3D icons (e.g., user selectable icons) despite being a flat surface rather than having an actual 3D surface as a 3D object. In particular, the disclosed system may provide a computationally efficient approach to create an illusion of depth to represent 3D aspects, elements, and objects in the shared artificial reality environment.

The disclosed system improves the functioning of the computer system used to generate the artificial reality environment and the artificial reality compatible devices used to connect to the environment. For example, such devices may include head mounted devices as described herein in which users may visually perceive the environment based on a left eye portion and a right eye portion of such head mounted devices. The disclosed system may provide for feeding two different images to each eye (i.e., right eye and left eye) via the head mounted devices. In this way, 3D illusions can be provided to achieve the effect of actual 3D rendered virtual elements without incurring the full extent of the corresponding processing cost and time. As an example, the virtual user interface may be perceived by users of the artificial reality compatible devices as having 3D depth and background rather than a flat “home tablet” user interface. In this way, the disclosed system also improves communication between the servers hosting the artificial reality environment and the artificial reality compatible devices. As such, the present invention is integrated into a practical application of applying stereoscopic textures for providing artificial reality elements with surfaces that have 3D depth.

Aspects of the present disclosure are directed to creating and administering artificial reality environments. For example, an artificial reality environment may be a shared artificial reality environment, a virtual reality (VR), an augmented reality environment, a mixed reality environment, a hybrid reality environment, a non immersive environment, a semi immersive environment, a fully immersive environment, and/or the like. The artificial environments may also include artificial collaborative gaming, working, and/or other environments which include modes for interaction between various people or users in the artificial environments. The artificial environments of the present disclosure may provide elements that enable users to navigate (e.g., scroll) in the environments via function expansions in the user's wrist, such as via pinching, rotating, tilting, and/or the like. The artificial environments may also enable the perception of 3D depth and background for rendered flat surfaces of 2D objects contained within the environments. As used herein, “real-world” objects are non-computer generated and artificial or VR objects are computer generated. For example, a real-world space is a physical space occupying a location outside a computer and a real-world object is a physical object having physical properties outside a computer. For example, an artificial or VR object may be rendered and part of a computer generated artificial environment.

Embodiments of the disclosed technology may include or be implemented in conjunction with an artificial reality system. Artificial reality, extended reality, or extra reality (collectively “XR”) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereoscopic features that produces a three-dimensional effect to the viewer). Additionally, in some implementations, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real-world after they have passed through a computing system. For example, a tablet with a camera on the back can capture images of the real-world and then display the images on the screen on the opposite side of the tablet from the camera. The tablet can process and adjust or “augment” the images as they pass through the system, such as by adding virtual objects. AR also refers to systems where light entering a users' eye is partially generated by a computing system and partially composes light reflected off objects in the real-world. For example, an AR headset could be shaped as a pair of glasses with a pass-through display, which allows light from the real-world to pass through a waveguide that simultaneously emits light from a projector in the AR headset, allowing the AR headset to present virtual objects intermixed with the real objects the user can see. The AR headset may be a block-light headset with video pass-through. “Artificial reality,” “extra reality,” or “XR,” as used herein, refers to any of VR, AR, MR, or any combination or hybrid thereof.

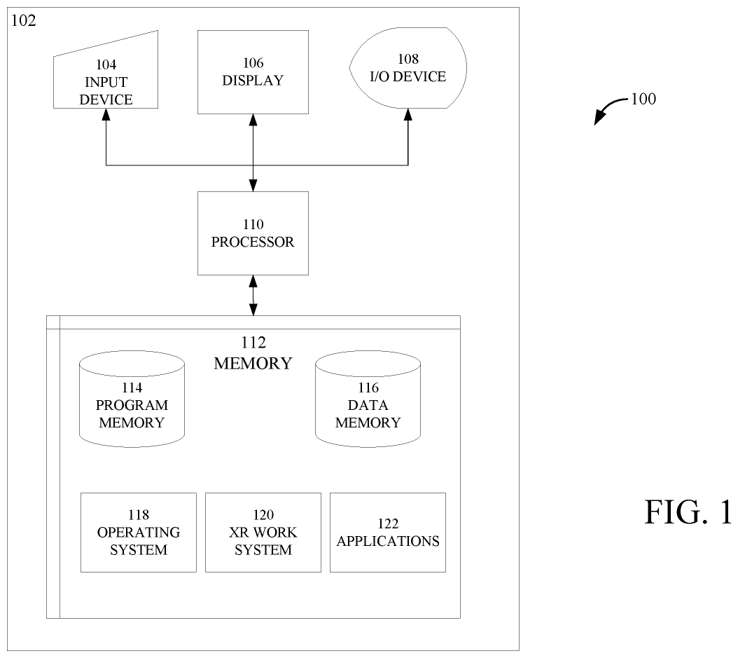

Several implementations are discussed below in more detail in reference to the figures. FIG. 1 is a block diagram of a device operating environment 100 with which aspects of the subject technology can be implemented. The device operating environment can comprise hardware components of a computing system 100 that can create, administer, and provide interaction modes for a shared artificial reality environment (e.g., collaborative artificial reality environment) such as for communication via XR elements as well as based on XR elements rendered with stereoscopic textures. The interaction modes can include various modes for various audio conversation, textual messaging, communicative gestures, control modes, and other communicative interaction, etc., for each user of the computing system 100. In various implementations, the computing system 100 can include a single computing device or multiple computing devices 102 that communicate over wired or wireless channels to distribute processing and share input data.

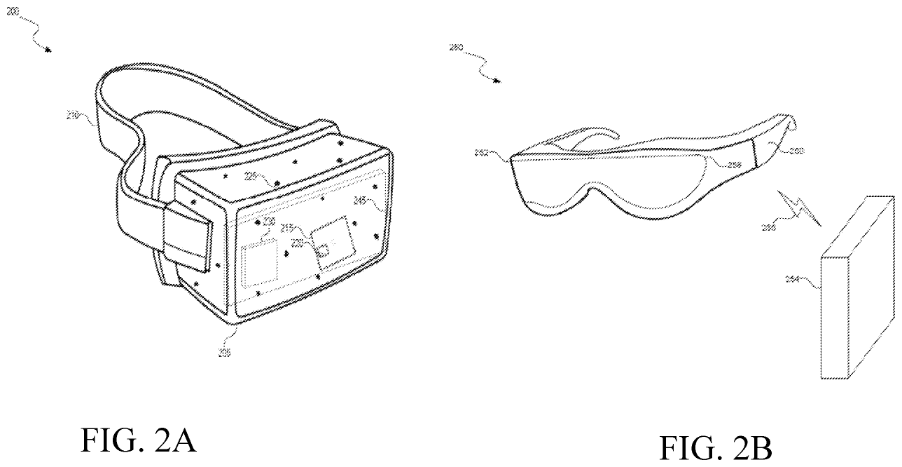

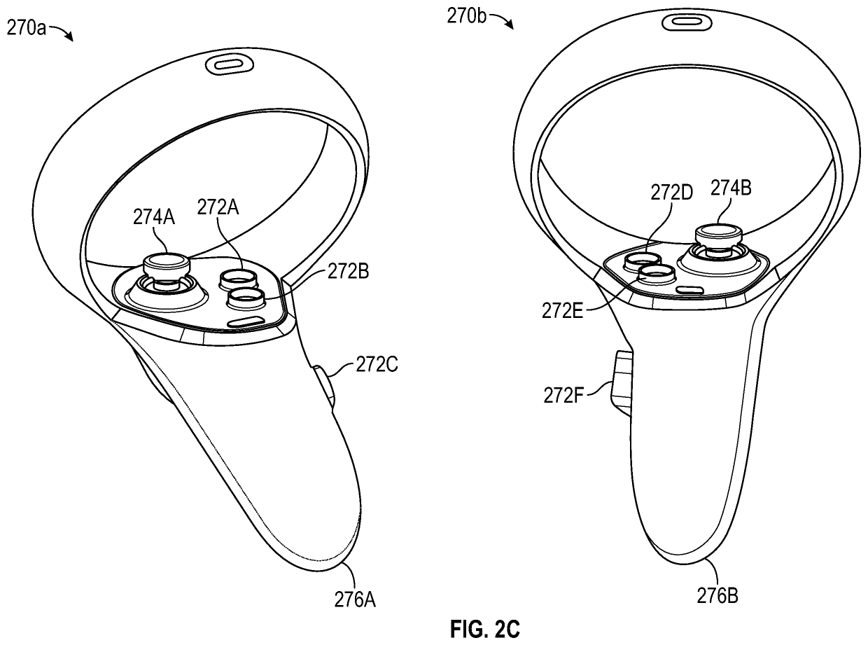

In some implementations, the computing system 100 can include a stand-alone headset capable of providing a computer created or augmented experience for a user without the need for external processing or sensors. In other implementations, the computing system 100 can include multiple computing devices 102 such as a headset and a core processing component (such as a console, mobile device, or server system) where some processing operations are performed on the headset and others are offloaded to the core processing component. Example headsets are described below in relation to FIGS. 2A-2B. In some implementations, position and environment data can be gathered only by sensors incorporated in the headset device, while in other implementations one or more of the non-headset computing devices 102 can include sensor components that can track environment or position data, such as for implementing computer vision functionality. Additionally or alternatively, such sensors can be incorporated as wrist sensors, which can function as a wrist wearable for detecting or determining user input gestures. For example, the sensors may include inertial measurement units (IMUs), eye tracking sensors, electromyography (e.g., for translating neuromuscular signals to specific gestures), time of flight sensors, light/optical sensors, and/or the like to determine the inputs gestures, how user hands/wrists are moving, and/or environment and position data.

The computing system 100 can include one or more processor(s) 110 (e.g., central processing units (CPUs), graphical processing units (GPUs), holographic processing units (HPUs), etc.). The processors 110 can be a single processing unit or multiple processing units in a device or distributed across multiple devices (e.g., distributed across two or more of computing device 102s). The computing system 100 can include one or more input devices 104 that provide input to the processors 110, notifying them of actions. The actions can be mediated by a hardware controller that interprets the signals received from the input device 104 and communicates the information to the processors 110 using a communication protocol. As an example, the hardware controller can translate signals from the input devices 104 to simulate navigation, such as for a user navigation to “walk around” a 2D object with stereoscopic texture to simulate 3D depth. Each input device 104 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, and/or other user input devices.

The processors 110 can be coupled to other hardware devices, for example, with the use of an internal or external bus, such as a PCI bus, SCSI bus, wireless connection, and/or the like. The processors 110 can communicate with a hardware controller for devices, such as for a display 106. The display 106 can be used to display text and graphics. In some implementations, the display 106 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and/or the like. Other I/O devices 108 can also be coupled to the processor, such as a network chip or card, video chip or card, audio chip or card, USB, firewire or other external device, camera, printer, speakers, CD-ROM drive, DVD drive, disk drive, etc.

The computing system 100 can include a communication device capable of communicating wirelessly or wire-based with other local computing devices 102 or a network node. The communication device can communicate with another device or a server through a network using, for example, TCP/IP protocols. The computing system 100 can utilize the communication device to distribute operations across multiple network devices. For example, the communication device can function as a communication module. The communication device can be configured to transmit or receive input gestures for determining navigation commands in XR environments or for XR objects. The communication device may also use input gestures to determine various types of user representation interaction with XR objects having stereoscopic textures applied to their constituent surfaces. Such XR objects can be rendered as objects in an XR museum within the artificial reality environment, for example. As an example, such XR objects may appear as 3D sculptures to a given user representation standing in front of them but appear as 2D flat images from a close or sided vantage point.

The processors 110 can have access to a memory 112, which can be contained on one of the computing devices 102 of computing system 100 or can be distributed across one of the multiple computing devices 102 of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. The memory 112 can include program memory 114 that stores programs and software, such as an operating system 118, XR work system 120, and other application programs 122 (e.g., XR games). The memory 112 can also include data memory 116 that can include information to be provided to the program memory 114 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, and/or the like.

FIGS. 2A-2B are diagrams illustrating virtual reality headsets, according to certain aspects of the present disclosure. FIG. 2A is a diagram of a virtual reality head-mounted display (HMD) 200. The HMD 200 includes a front rigid body 205 and a band 210. The front rigid body 205 includes one or more electronic display elements such as an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in a virtual environment in three degrees of freedom (3DoF), six degrees of freedom (6DoF), etc. For example, the locators 225 can emit infrared light beams which create light points on real objects around the HMD 200. As another example, the IMU 215 can include, e.g., one or more accelerometers, gyroscopes, magnetometers, other non-camera-based position, force, or orientation sensors, or combinations thereof. One or more cameras (not shown) integrated with the HMD 200 can detect the light points, such as for a computer vision algorithm or module. The compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by the link 256. In other implementations, the mixed reality system 250 includes a headset only, without an external compute device or includes other wired or wireless connections between the mixed reality HMD 252 and the core processing component 254. The mixed reality system 250 may also include a wrist wearable, such as for converting wrist input gestures into navigation commands for movement and interaction in XR environments (e.g., with stereoscopic features). The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc. The electronic components may be configured to implement computing vision-based hand tracking for translating hand movements and positions to XR navigation or selection commands, such as for holding stereoscopic XR objects.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the users' eye. The output light can mix with light that passes through the display 258, allowing the output light to present virtual objects that appear as if they exist in the real-world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects. For example, the HMD system 250 can track the motion and position of user's wrist movements as input gestures for performing navigation such as scrolling of XR objects in a manner that is mapped to the input gestures. As an example, the HMD system 250 may include a coordinate system to track the relative hand positions for each user for determining how the user desires to scroll through, manipulate XR elements, and/or interact with the artificial reality environment. In this way, the HMD system 250 can enable users to have a natural response and intuitive sense of controlled interaction with their hands.

FIG. 2C illustrates controllers 270a-270b, which, in some implementations, a user can hold in one or both hands to interact with an artificial reality environment presented by the HMD 200 and/or HMD 250. The controllers 270a-270b can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The compute units 230 may, via the IMU outputs (or other sensor outputs via the controllers 270a-270b), compute a change in position of the user's hand for defining an input gesture. The controllers 270a-270b can also include various buttons (e.g., buttons 272A-F) and/or joysticks (e.g., joysticks 274A-B), which a user can actuate to provide input and interact with objects.

As discussed below, controllers 270a-270b can also have tips 276A and 276B, which, when in scribe controller mode, can be used as the tip of a writing implement in the artificial reality environment. The controllers 270a-270b may be used to change a perception angle of a given XR element with surfaces having stereoscopic textures, for example. In various implementations, the HMD 200 or 250 can also include additional subsystems, such as a hand tracking unit, an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the users' hands to determine gestures and other hand and body motions.

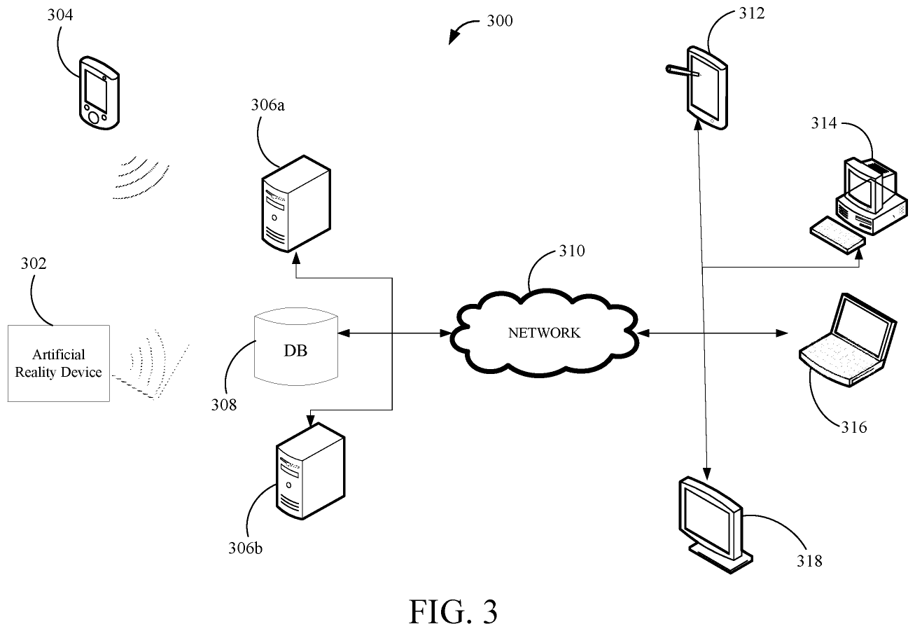

FIG. 3 is a block diagram illustrating an overview of an environment 300 in which some implementations of the disclosed technology can operate. Environment 300 can include one or more client computing devices, such as artificial reality device 302, mobile device 304, tablet 312, personal computer 314, laptop 316, desktop 318, and/or the like. The artificial reality device 302 may be the HMD 200, HMD system 250, or some other XR device that is compatible with rendering or interacting with an artificial reality or virtual reality environment. The artificial reality device 302 and mobile device 304 may communicate wirelessly via the network 310. In some implementations, some of the client computing devices can be the HMD 200 or the HMD system 250. The client computing devices can operate in a networked environment using logical connections through network 310 to one or more remote computers, such as a server computing device. Content (e.g., for communication in a shared artificial reality or communication environment) can be provided to the client computing devices via the server computing device, such as including 2D objects with stereoscopic textures applied to their surfaces. The stereoscopic textures may be pre-rendered or may be created in real-time. For example, the stereoscopic textures may be generated by the server computing device executing computer graphics software such as Autodesk Maya (available from Autodesk Inc. of Mill Valley, CA) and/or Unity (available from Unity Technologies of San Francisco, Calif.).

In some implementations, the environment 300 may include a server such as an edge server which receives client requests and coordinates fulfillment of those requests through other servers. The server may include the server computing devices 306a-306b, which could also logically form a single server. Alternatively, the server computing devices 306a-306b may each be a distributed computing environment encompassing multiple computing devices located at the same or at geographically disparate physical locations. The client computing devices and server computing devices 306a-306b can each act as a server or client to other server/client device(s). The server computing devices 306a-306b can connect to a database 308 or can comprise its own memory. Each server computing devices 306a-306b can correspond to a group of servers, and each of these servers can share a database or can have their own database. The database 308 may logically form a single unit or may be part of a distributed computing environment encompassing multiple computing devices that are located within their corresponding server, located at the same, or located at geographically disparate physical locations.

The client computing devices and the server computing devices 306a-306b may be in operative communication to facilitate movement and interaction about the artificial reality environment. As an example, user representations may hold XR objects such as virtual still images with stereoscopic textures for 3D characteristics. For example, the XR objects may be rendered 2D XR objects that can be perceived as 3D objects when held. As an example, an example XR object may be a three-dimensional trading card with stereoscopic textured surfaces that has three-dimensional depth from a front angle, but appears as a flat plane from a sided angle. The stereoscopic textures can be pre-rendered and stored in the database 308. Moreover, render textures and stereoscopic characteristics may also be stored in the database 308. For example, stereoscopic camera parameter data including focal length, interaxial separation, zero parallax, rotation angle, and/or the like can be stored in the database 308. Also, the server computing devices 306a-306b may implement a custom shader to assign render textures for the stereoscopic textures for each eye of a user wearing the HMD 200 or 250. That is, the server computing devices 306a-306b can feed two separate images at different angles to each eye of the user, which can be combined to create an illusion of a 3D effect.

The network 310 can be a local area network (LAN), a wide area network (WAN), a mesh network, a hybrid network, or other wired or wireless networks. The network 310 may be the Internet or some other public or private network. Client computing devices can be connected to network 310 through a network interface, such as by wired or wireless communication. The connections can be any kind of local, wide area, wired, or wireless network, including the network 310 or a separate public or private network. In some implementations, the server computing devices 306a-306b can be used as part of a social network such as implemented via the network 310. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc.

Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea. A social networking system can enable a user to enter and display information related to the users' interests, age/date of birth, location (e.g., longitude/latitude, country, region, city, etc.), education information, life stage, relationship status, name, a model of devices typically used, languages identified as ones the user is familiar with, occupation, contact information, or other demographic or biographical information in the users' profile. Any such information can be represented, in various implementations, by a node or edge between nodes in the social graph.

A social networking system can enable a user to upload or create pictures, videos, documents, songs, or other content items, and can enable a user to create and schedule events. Content items can be represented, in various implementations, by a node or edge between nodes in the social graph. A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels (e.g., encrypted, non-encrypted, or partially encrypted) to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (via their avatar or true-to-life representation) with objects or other avatars in a virtual environment (e.g., in an artificial reality working environment), etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide a virtual environment where users can communicate and interact via avatars or other digital representations of themselves. Further, a first user can comment on the profile page of a second user or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

In particular embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identifies a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular embodiments, privacy settings may be based on one or more nodes or edges of a social graph. A privacy setting may be specified for one or more edges or edge-types of the social graph, or with respect to one or more nodes, or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system. The object may be associated with a concept node connected to a user node of the first user by an edge. The first user may specify privacy settings that apply to a particular edge connecting to the concept node of the object, or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

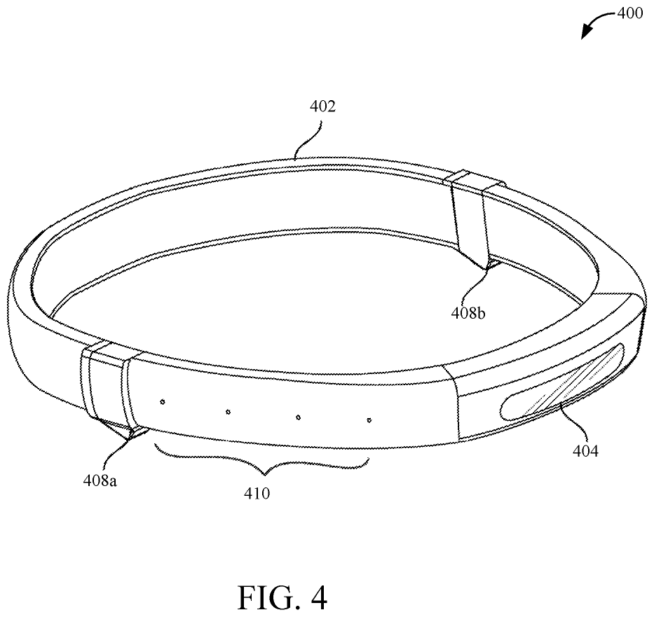

FIG. 4 illustrates an example artificial reality wearable for a shared artificial reality environment, according to certain aspects of the present disclosure. For example, the artificial reality wearables can be a wrist wearable such as an XR wrist sensor 400. The wrist sensor 400 may be configured to sense position and movement of a user's hand in order to translate such sensed position and movement into input gestures. For example, the input gestures may be micro movements of the user's wrist. Various input gestures can be used to interact with stereoscopic textures based on various scale, size, or shape of stereoscopically textured surfaces. For example, a circle shaped XR portal can have an illusion of a 3D geometry based on the stereoscopic textures of the present disclosure rather than the computationally expensive modeling and rendering of 3D geometry in the environment. Advantageously, the stereoscopically textured 2D XR objects interacted with via the XR wrist sensor 400 can include pre-generated textures rather than rendering in real-time for each frame. One texture can be pre-generated for each eye of various users, such as via the HMD 200 or the HMD system 250. The XR wrist sensor 400 may generally represent a wearable device dimensioned to fit about a body part (e.g., a wrist) of the user. As shown in FIG. 4, the XR wrist sensor 400 may include a frame 402 and a sensor assembly 404 that is coupled to frame 402 and configured to gather information about a local environment by observing the local environment.

The sensor assembly 404 can include cameras, IMU eye tracking sensors, electromyography (EMG) sensors, time of flight sensors, light/optical sensors, and/or the like to track wrist movement. The XR wrist sensor 400 may also include one or more audio devices, such as output audio transducers 408a-408b and input audio transducers 410. The output audio transducers 408a-408b may provide audio feedback and/or content to the user while the input audio transducers 410 may capture audio in the user's environment. The XR wrist sensor 400 may also include other types of screens or visual feedback devices (e.g., a display screen integrated into a side of frame 402). The audio, visual, and/or other types of feedback can be provided based on the type of stereoscopic texture applied to a surface of a given XR object interacted with by the user. The stereoscopic textures of such XR objects advantageously can be computational efficient and lightweight for representing complex 3D geometries with textures. In some embodiments, the wrist wearable 400 can instead take another form, such as head bands, hats, hair bands, belts, watches, ankle bands, rings, neckbands, necklaces, chest bands, eyewear frames, and/or any other suitable type or form of apparatus. Other forms of the XR wrist sensor 400 may be different wrist bands with a different ornamental appearance than the XR wrist sensor 400 but perform a similar function.

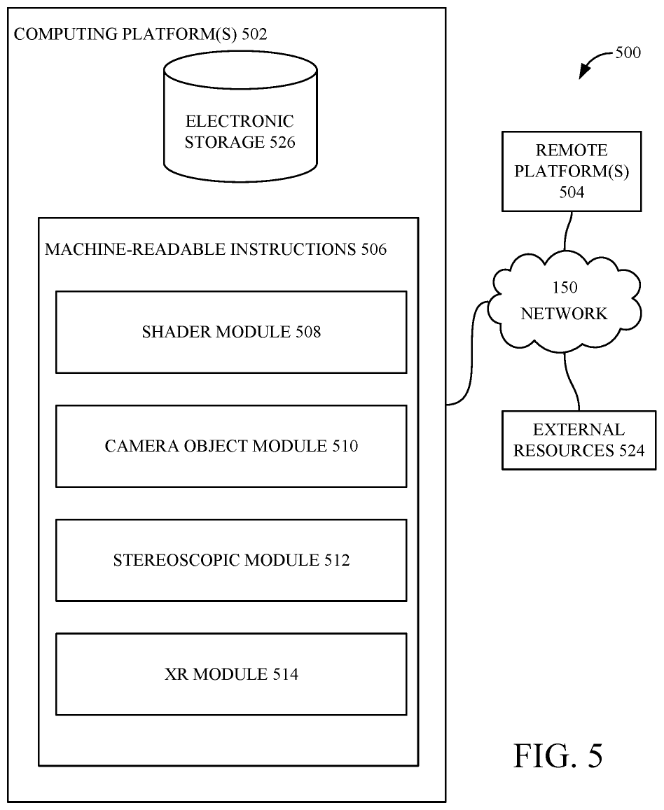

FIG. 5 is a block diagram illustrating an example computer system 500 (e.g., representing both client and server) with which aspects of the subject technology can be implemented. The system 500 may be configured for stereoscopic features in a shared artificial reality environment, according to certain aspects of the disclosure. In some implementations, the system 500 may include one or more computing platforms 502. The computing platform(s) 502 can correspond to a server component of an artificial reality/XR platform or other communication platform, which can be similar to or the same as the server computing devices 306a-306b of FIG. 3 and include the processor 110 of FIG. 1. The computing platform(s) 502 can render the shared XR environment according to user preferences, for example. The computing platform(s) 502 can be configured to store, render, modify, and/or otherwise control stereoscopic features, surfaces, and/or XR elements in the environment. For example, the computing platform(s) 502 may be configured to execute algorithm(s) to determine how left and right eye camera projections (e.g., for flat surfaces) should be routed/allocated via a shader and combined at an XR compatible client device (e.g., HMD 200, HMD system 250) of the remote platform(s) 504 to implement pre-rendered or real-time rendered stereoscopic textures in the shared artificial reality environment.

The computing platform(s) 502 can maintain or store pairs of images, such as in the electronic storage 526, including optical viewpoints of images (e.g., of the same view surface) used by the computing platform(s) 502 to determine how to mimic human eye perception. As an example, the computing platform(s) 502 can use image pairs to render a 3D scene in the XR environment via side by side computer graphics cameras for superimposition upon each other of the pairs of images for the left eye and right eye. The computing platform(s) 502 may be configured to communicate with one or more remote platforms 504 according to a client/server architecture, a peer-to-peer architecture, and/or other architectures. The remote platform(s) 504 may be configured to communicate with other remote platforms via computing platform(s) 502 and/or according to a client/server architecture, a peer-to-peer architecture, and/or other architectures. Users may access the system 500 hosting the shared artificial reality environment and/or personal artificial reality via remote platform(s) 504. In this way, the remote platform(s) 504 can be configured to cause output of the shared artificial reality environment on client device(s) of the remote platform(s) 504, such as via the HMD 200, HMD system 250, and/or controllers 270a-270b of FIG. 2C. As an example, the remote platform(s) 504 can access artificial reality content and/or artificial reality applications for use in the shared artificial reality for the corresponding user(s) of the remote platform(s) 504, such as via the external resources 524. The computing platform(s) 502, external resources 524, and remote platform(s) 504 may be in communication and/or mutually accessible via the network 150.

The computing platform(s) 502 may be configured by machine-readable instructions 506. The machine-readable instructions 506 may be executed by the computing platform(s) to implement one or more instruction modules. The instruction modules may include computer program modules. The instruction modules being implemented may include one or more of shader module 508, camera object module 510, stereoscopic module 512, XR module 514, and/or other instruction modules.

As discussed herein, the shader module 508 can implement a shader component for stereoscopic textures in the shared XR environment, such as for each XR compatible device of the remote platforms(s) 504 that can be used to access the environment. The shader module 508 can implement code in Unity, some other computer graphics software, or any suitable digital asset creation tool, for example. For each stereoscopic texture applied in the computer graphics software, a 3D surface may be created. The shader module 508 can apply a customized shader to the 3D surface, such as for a virtual element in an XR area of the shared XR environment. The shader module 508 may apply the shader for a pre-rendered stereoscopic texture or a real-time stereoscopic texture. In particular, the shader module 508 may assign a portion (e.g., half) of each stereoscopic texture to a corresponding optical viewpoint, such as for a left eye viewpoint or a right eye viewpoint of a particular user of the XR compatible client device. For example, the shader module 508 may assign portions of stereoscopic textures to corresponding eyes of the HMD 200, HMD system 250, or other XR headset while accounting for a slight offset in view between the left eye viewpoint and the right eye viewpoint.

For example, the shader module 508 may assign portions iteratively to the left eye viewpoint and the right eye viewpoint based on a stereo eye index. For real-time stereoscopic textures, which can be dynamically created for different types of XR scenes, two render textures can be created at runtime and assigned to each eye (e.g., the left eye viewpoint and the right eye viewpoint) for each frame of a subject XR scene. That is, the shader module 508 can assign render textures for a left eye stereoscopic camera and a right eye stereoscopic camera. The shader module 508 can apply a color attribute for each assigned pixel, such as white. Also, the shader module 508 can render textures in an opaque manner or a transparent manner. The shader module 508 may also apply stereo instancing, such as in Unity. In stereo instancing, the shader module 508 can perform an angle render pass, replacing each draw call with an instanced draw call, which advantageously reduces CPU use, GPU use, and power consumption, such as due to cache coherency between the two draw calls. For example, initializing a vertex output stereo macro can enable the GPU to determine which eye in the texture array it should render to, based on the value of the stereo eye index.

The camera object module 510 may implement a plurality of stereoscopic camera objects, such as in Maya or another suitable digital asset creation tool. The camera object module 510 may control perspectives and optical viewpoints for animation, modeling, simulation, and rendering of XR objects and other elements in the shared XR environment. The camera object module 510 can initiate a pair of stereoscopic camera objects, such as one for the particular user's left eye and for the right eye. The left eye stereoscopic camera object and the right eye stereoscopic camera object may provide optical viewpoints for the shared XR environment, such as being separated by an offset in distance to simulate human vision. Moreover, the left eye stereoscopic camera object and the right eye stereoscopic camera object can be tilted so that the combined views converge at a slight angle to mimic human vision with two eyes. In particular, the left eye stereoscopic camera object and the right eye stereoscopic camera object may render respective views of XR areas at a first and second camera angle, respectively. The respective views at the first and second camera angle may be combined and routed/fed to each eye of the HMD 200 or HMD system 250.

The camera object module 510 can be, include, or implement a stereoscopic camera for rendering virtual scenes/areas within the shared XR environment. The created stereoscopic camera objects of the camera object module 510 can operate in a plurality of viewing modes, such as horizontal interlace, perspective, top, and anaglyph viewing modes and/or the like. The camera object module 510 can also set a background color for whatever viewing mode is used. The camera object module 510 may set, determine, or change a plurality of attributes or settings for the plurality of stereoscopic camera objects. For example, the plurality of attributes can include a zero parallax plane attribute, viewing volume attribute, interaxial separation attribute, and zero parallax attribute, etc. As an example, the camera object module 510 can set the interaxial separation attribute within a human interpupillary distance, dynamically adjust the zero parallax attribute from one XR scene to another, and/or apply a fifth millimeter focal length lens for the stereoscopic camera objects. In general, the stereo camera parameters of the camera object module 510 can be adjusted as XR scenes in the shared XR environment change. The zero parallax plane attribute can refer to a plane to define positive parallax and negative parallax. Positive parallax can refer to a stereoscopic texture object being behind the zero parallax surface while negative parallax can refer to the stereoscopic texture object being in front of the zero parallax surface.

Accordingly, the zero parallax attribute can be adjusted by the camera object module 510 for the comfort of viewing or perceiving the stereoscopic texture object. For example, zero parallax can be increased to move perceived objects including the stereoscopic texture object away from the viewing user. For example, zero parallax can be decreased to move perceived objects including the stereoscopic texture object closer to the viewing user, which can increase the perceived 3D depth of the stereoscopic texture object. The 3D depth may be more realistic when the zero parallax plane is between various XR objects in the XR area of the shared XR environment. The interaxial separation attribute may be set by the camera object module 510 to control how close or far away the left eye stereoscopic camera object and the right eye stereoscopic camera object are from each other. Such a distance can be adjusted for viewing comfort or the desired human stereo vision simulated for the stereoscopic texture object. As an example, the left eye stereoscopic camera object and the right eye stereoscopic camera object can be placed slightly apart via a small interaxial separation attribute set by the camera object module 510 to mimic perception by a human left eye and right eye, such as for real-time rendering of stereoscopic textures via created render textures.

The stereoscopic module 512 may render pairs of still images for each eye of the particular user, such as by feeding a pair of images to the corresponding left eye and the right eye portion of the HMD 200 and/or HMD system 250. In this way, the stereoscopic module 512 can simulate 3D vision and/or perception of an XR surface, such as of a user interface, scarf virtual object, virtual thumbnail, or other XR element, etc. The stereoscopic module 512 can generate stereoscopic textures based on the pairs of images, which can be applied to XR surfaces by the shader module 508 to create 3D effects/surfaces for 2D XR elements. As an example, the stereoscopic module 512 can create render textures at an aspect ratio matching a target viewing surface. Such render textures may be pre-allocated by the shader module 508 or can be generated at run-time if pre-allocation is not necessary. The stereoscopic textures for surfaces can impart 3D depth in a computationally inexpensive manner (e.g., without having to generate associated 3D geometry), which addresses limitations in the computing power available to render the shared XR environment. The stereoscopic module 512 may control perception of the 3D vision and/or perception based on how a textured surface of the stereoscopic texture object is perceived. As an example, the stereoscopic module 512 may set a distance between the textured surface and the user representation viewer in the shared XR environment in order to determine a desirable binocular disparity (the distance can vary directly with the binocular disparity). As discussed herein, because the stereoscopic module 512 is configured to manipulate textures, the 3D depth perception of the stereoscopic texture object does not apply for Z-axis rotation angles (e.g., viewing the flat surface of the object from the side).

The XR module 514 may be used to render the shared artificial reality environment for remote platform(s) 504 via the computing platform(s) 502, for example. The XR module 514 may be in communication with an XR compatible device used to access the environment such as HMDs 200, 250, or some other type of XR applicable device (e.g., XR headset). The XR module 514 may generate XR representations of various objects such as images, shapes, thumbnails, icons, portals, and/or the like. The visual rendering of elements by the XR module 514 can be 2D, 3D, or flat surfaces with stereoscopic textures to imitate 3D depth. The XR module 514 can render various virtual areas, space, and/or XR scenes such as a museum, public art space, home area, and/or the like. XR objects having flat surfaces can be visually and/or graphically rendered by the XR module 514 with 3D effect and depth based on stereoscopic textures being applied to such objects. As such, the XR module 514 can provide dimensional XR objects (e.g., 2D objects having simulated 3D depth), including dimensional user interfaces, icons, flat cards (e.g., posters, wallpapers, etc.), and/or the like such that users can perceive 3D aspects of XR textures for XR surfaces. In this way, the XR module 514 may render the shared XR environment to client devices (e.g., XR compatible devices) of the remote platform(s) 504, such as for the users of the XR compatible devices to touch, move, control, or otherwise virtually manipulate such objects in the shared XR environment.

In some implementations, the computing platform(s) 502, the remote platform(s) 504, and/or the external resources 524 may be operatively linked via one or more electronic communication links. For example, such electronic communication links may be established, at least in part, via the network 310 such as the Internet and/or other networks. It will be appreciated that this is not intended to be limiting, and that the scope of this disclosure includes implementations in which the computing platform(s) 502, the remote platform(s) 504, and/or the external resources 524 may be operatively linked via some other communication media.

A given remote platform 504 may include client computing devices, such as the artificial reality device 302, mobile device 304, tablet 312, personal computer 314, laptop 316, and desktop 318, which may each include one or more processors configured to execute computer program modules (e.g., the instruction modules). The computer program modules may be configured to enable an expert or user associated with the given remote platform 504 to interface with the system 500 and/or external resources 524, and/or provide other functionality attributed herein to remote platform(s) 504. By way of non-limiting example, a given remote platform 504 and/or a given computing platform 502 may include one or more of a server, a desktop computer, a laptop computer, a handheld computer, a tablet computing platform, a NetBook, a Smartphone, a gaming console, and/or other computing platforms. The external resources 524 may include sources of information outside of the system 500, external entities participating with the system 500, and/or other resources. For example, the external resources 524 may include externally designed XR elements and/or XR applications designed by third parties. In some implementations, some or all of the functionality attributed herein to the external resources 524 may be provided by resources included in system 500.

The computing platform(s) 502 may include the electronic storage 526, a processor such as the processors 110, and/or other components. The computing platform(s) 502 may include communication lines, or ports to enable the exchange of information with a network and/or other computing platforms. Illustration of the computing platform(s) 502 in FIG. 5 is not intended to be limiting. The computing platform(s) 502 may include a plurality of hardware, software, and/or firmware components operating together to provide the functionality attributed herein to the computing platform(s) 502. For example, the computing platform(s) 502 may be implemented by a cloud of computing platforms operating together as the computing platform(s) 502.

The electronic storage 526 may comprise non-transitory storage media that electronically stores information, such as contextual information including location, quantity of user representations, and correlations. The electronic storage media of the electronic storage 526 may include one or both of system storage that is provided integrally (i.e., substantially non-removable) with computing platform(s) 502 and/or removable storage that is removably connectable to computing platform(s) 502 via, for example, a port (e.g., a USB port, a firewire port, etc.) or a drive (e.g., a disk drive, etc.). The electronic storage 526 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 526 may include one or more virtual storage resources (e.g., cloud storage, a virtual private network, and/or other virtual storage resources). The electronic storage 526 may store software algorithms, information determined by the processor(s) 110, information received from computing platform(s) 502, information received from the remote platform(s) 504, and/or other information that enables the computing platform(s) 502 to function as described herein.

The processor(s) 110 may be configured to provide information processing capabilities in the computing platform(s) 502. As such, the processor(s) 110 may include one or more of a digital processor, an analog processor, a digital circuit designed to process information, an analog circuit designed to process information, a state machine, and/or other mechanisms for electronically processing information. Although the processor(s) 110 is shown in FIG. 1 as a single entity, this is for illustrative purposes only. In some implementations, the processor(s) 110 may include a plurality of processing units. These processing units may be physically located within the same device, or the processor(s) 110 may represent processing functionality of a plurality of devices operating in coordination. Processor(s) 110 may be configured to execute modules 508, 510, 512, 514, and/or other modules. Processor(s) 110 may be configured to execute modules 508, 510, 512, 514, and/or other modules by software; hardware; firmware; some combination of software, hardware, and/or firmware; and/or other mechanisms for configuring processing capabilities on the processor(s) 110. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although the modules 508, 510, 512, and/or 514 are illustrated in FIG. 5 as being implemented within a single processing unit, in implementations in which the processor(s) 110 includes multiple processing units, one or more of the modules 508, 510, 512, and/or 514 may be implemented remotely from the other modules. The description of the functionality provided by the different modules 508, 510, 512, and/or 514 described herein is for illustrative purposes, and is not intended to be limiting, as any of the modules 508, 510, 512, and/or 514 may provide more or less functionality than is described. For example, one or more of the modules 508, 510, 512, and/or 514 may be eliminated, and some or all of its functionality may be provided by other ones of the modules 508, 510, 512, and/or 514. As another example, the processor(s) 110 may be configured to execute one or more additional modules that may perform some or all of the functionality attributed below to one of the modules 508, 510, 512, and/or 514.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

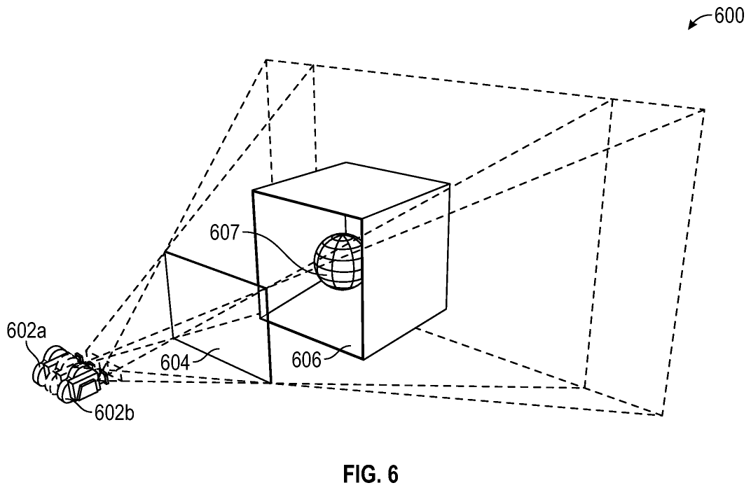

FIG. 6 is a block diagram 600 illustrating an example stereoscopic camera system with which aspects of the subject technology can be implemented. At least one stereoscopic camera rig can be established, such as in Maya or another digital asset creation or computer graphics software, in order to instantiate a left eye camera object 602a and a right eye camera object 602b. The left eye camera object 602a and a right eye camera object 602b may be applied to a created or imported 3D scene 606 for a pre-rendered or a real-time generated stereoscopic texture. The position of the stereoscopic camera rig may be adjusted for interaxial distance of the left eye camera object 602a and a right eye camera object 602b so that the difference in height, vertical angle, focus, distance apart, positioning, and/or the like can be controlled or adjusted as desired to maintain a desirable 3D effect for stereoscopic textures applied to surfaces (e.g., of 2D XR objects) in a shared artificial reality environment. The left eye camera object 602a and the right eye camera object 602b can be applied to the 3D scene 606 via a zero parallax surface 604. When combined with a custom shader as described herein, the sphere 607 with the 3D scene 606 can have a stereoscopic texture applied to its surface such that the sphere 607 appears to have 3D depth. The zero parallax surface 604 may be a setting controlled by the example stereoscopic camera system, such as to set a distance to the zero parallax surface 604 measured from the left eye camera object 602a and/or the right eye camera object 602b.

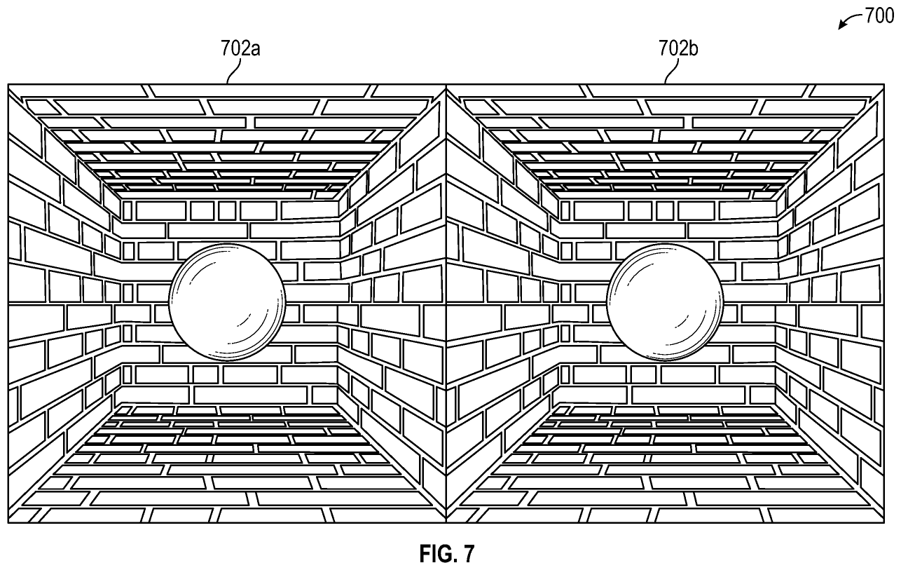

As described herein, the zero parallax surface 604 may be defined as a set of points in space whose left and right projections overlap at the same spot in the displayed 3D scene 606 and the zero parallax surface 604 may coincide with the viewing surface. XR objects between the left eye camera object 602a and/or the right eye camera object 602b and the zero parallax surface 604 appear to the viewer in front of the viewing screen, and objects behind the zero parallax surface 604 appear to the viewer behind the viewing screen. Each of the left eye camera object 602a and/or the right eye camera object 602b can be or include sub-cameras. The left eye camera object 602a and/or the right eye camera object 602b can be configured to render corresponding stereo camera views to pairs of image files, such as shown in FIG. 7. Various settings, output planes, and output files can be set or adjusted separately for the left and right channels corresponding to the left eye camera object 602a and the right eye camera object 602b. The left eye camera object 602a and the right eye camera object 602b may form a stereoscopic camera for the example stereoscopic camera system to render stereoscopic textures. For example, the left eye camera object 602a can render an individual image for the left eye and another individual image for the right eye. The right eye camera object 602b can render an individual image for the left eye and another individual image for the right eye such that the pairs of images may be combined for the optical viewpoint of each eye.

In this way, human stereo vision can be simulated for rendered stereoscopic textures so that they have 3D depth and dimensionality. A camera tilt can be applied to converge to the images from pairs from the left optical viewpoint and the right optical viewpoint. Various settings can be used to adjust the optical viewpoint and/or projection of the left eye camera object 602a and/or the right eye camera object 602b, such as focal length, interaxial separation, and zero parallax value. Focal length for both of the left eye camera object 602a and the right eye camera object 602b may be set for a fifty millimeter lens to accurately simulate stereo vision from human eyes. Stereoscopic textures rendered from wide lens such as less than twenty five millimeter lens can be distorted and cause discomfort when being viewed. The interaxial separation defines the distance between the left eye camera object 602a and the right eye camera object 602b and should be kept within an average range of human interpupillary distance to reduce or minimize discomfort when viewing. Increasing or decreasing the interaxial separation can strengthen or weaken the stereo effect of rendered stereoscopic textures, respectively. The zero parallax value may be dynamically adjusted between different XR areas or scenes based on the distance to the zero parallax surface 604 that is desired for the corresponding type of XR area or scene.

FIG. 7 is a block diagram 700 illustrating an example stereoscopic texture for a shared artificial reality environment, according to certain aspects of the present disclosure. The example stereoscopic texture may be applied to a plain image having a flat surface as a 2D XR object. Stereoscopic cameras and a custom shader may be used to generate and allocate image pairs for the example stereoscopic texture. For example, the stereoscopic cameras can capture two adjacent images corresponding to a left eye image 702a and a right eye image 702b, respectively. The left eye image 702a and the right eye image 702b of the brick wall including a sphere as shown in FIG. 7 may appear identical but actually have a slight offset in angle relative to each other to create an illusion of three-dimensionality. As such, a customized shader may be used to assign the correct portion of the example stereoscopic texture (e.g., via the left eye image 702a and a right eye image 702b) for a 3D rendering of the XR scene with the brick wall and sphere. The portions can be assigned correctly to the left eye and right eye portions of the HMD 200 or HMD system 250, for example. Only portions rather than both of the left eye image 702a and a right eye image 702b are seen simultaneously, which enables the illusion of three-dimensionality. In this way, the example stereoscopic texture can be created as pre-rendered textures (e.g., in Unity software) and applied to XR objects or elements in various scenes of the shared XR environment. Also, the example stereoscopic texture can be applied to complex surface geometries such as in real-time via the custom shared to appropriately apportion the example stereoscopic texture.

Advantageously, images pairs such as the left eye image 702a and the right eye image 702b can be superimposed for the HMD 200 or HMD system 250 or other XR compatible headset/device to mimic 3D stereo vision in the human brain so that 2D XR objects may be perceived as having 3D depth, which achieves computationally efficient high fidelity 3D type imagery without incurring the significant cost of generating actual 3D geometry in the shared artificial reality environment. The example stereoscopic texture can be applied to various user interfaces and other XR elements or applications as surface textures for 3D perception in the XR environment. That is, the left eye image 702a and the right eye image 702b can function as an image pair to mimic the human eye's stereo vision capability via subtly different angles of the same XR scene. The interaxial separation of stereoscopic camera objects for the left eye image 702a and the right eye image 702b can be increased to change (e.g., increase) the perceived 3D depth. For a screen size and viewing distance associated with the left eye image 702a and the right eye image 702b, a maximum positive parallax and maximum negative parallax can be defined. Parallax values exceeding the maximum positive parallax can cause divergence while parallax values exceeding the maximum negative parallax can also impair the 3D depth perception. Positive parallax can be defined as being viewed behind the screen because the left eye image 702a is located to the left of the right eye image 702b. Negative parallax can be defined as being viewed in front of the screen because the right eye image 702b is located to the right of the right eye image 702b.

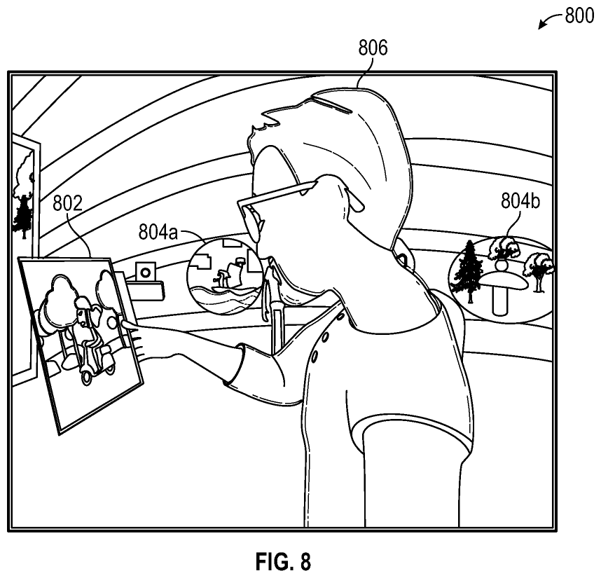

FIG. 8 is a block diagram 800 illustrating an example stereoscopic texture in an example virtual scene of a shared artificial reality environment, according to certain aspects of the present disclosure. A stereoscopic textured object 802 may be a still image having a surface with a rendered stereoscopic texture, for example. Moreover, the stereoscopic textured object 802 could be an XR portal, user interface, thumbnail (e.g., of an app), trailer, icon, art installation, window, trading card, movie, decal, poster, wallpaper, or some other suitable XR object having a surface to which stereoscopic textures/features can be applied. The stereoscopic textured object 802 can be held by a user representation 806 in the shared XR environment, such as depending on what type of XR object it is. Users may experience the shared artificial reality environment with a layer of dimensionality that does not exist for 2D computer display screens. For example, the user corresponding to the user representation 806 can experience the sensation of holding a 3D object via the simulation of 3D depth provided by the textured surfaces of the stereoscopic textured object 802. For example, if the stereoscopic textured object 802 represented an XR object with a flat surface such as an ATM machine, the stereoscopic texture disclosed in the present disclosure can add perception of depth to the ATM machine. Similarly, the user corresponding to the user representation 806 can perceive a 3D depth and dimensionality of the portals 804a-804b and constituent elements contained therein.

As used herein, the portals 804a-804b can function as deep links or otherwise transition points for moving between various XR worlds (e.g., closed or open). For example, the user representation 806 may stand in front of or be in the vicinity of the portals 804a-804b to be transported in the shared XR environment from the existing XR scene to another XR scene linked and/or displayed by the portals 804a-804b. As such, the portals 804a-804b can depict the another XR scene with 3D depth. As described herein, the example stereoscopic texture of FIG. 8 may be perceived as having a 3D appearance in the shared artificial reality environment, such as based on having an illusion of depth. The stereoscopic camera object and shader configuration of the present disclosure can create and/or adjust (e.g., depending on a zero parallax surface) a type of three-dimensional effect based on how slightly different images pairs (e.g., perceived with parallax by human eyes) fed/routed to the left eye and the right eye of the user are combined or fused for depth perception. In this way, the left eye and the right eye converge across the different image pairs routed to each eye so that the XR flat surface upon which the XR stereoscopic texture is applied may be provided with a simulation of 3D depth for the user of the corresponding user representation located in the XR environment.

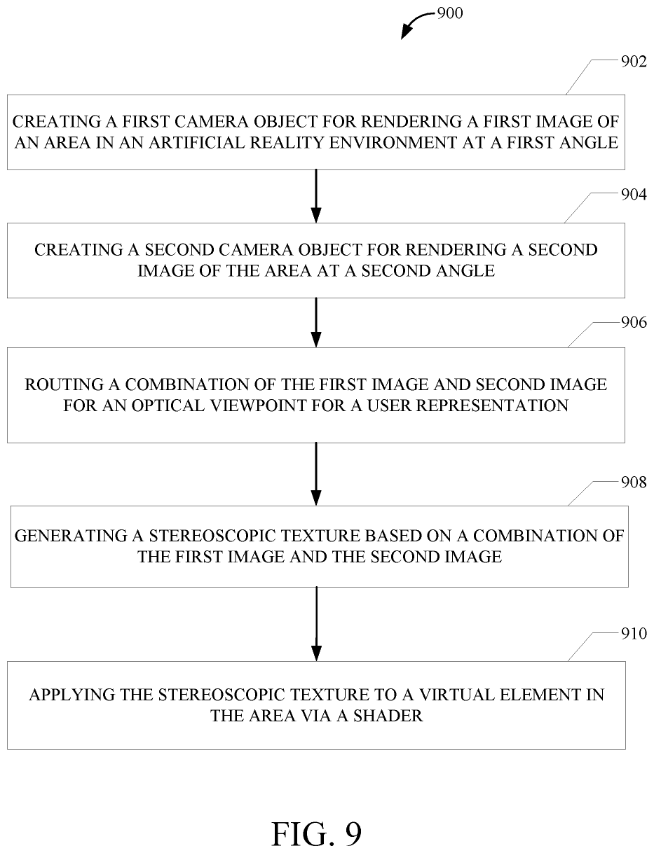

FIG. 9 illustrates an example flow diagram (e.g., process 900) for selective encryption in a shared artificial reality environment, according to certain aspects of the disclosure. For explanatory purposes, the example process 900 is described herein with reference to one or more of the figures above. Further for explanatory purposes, the steps of the example process 900 are described herein as occurring in serial, or linearly. However, multiple instances of the example process 900 may occur in parallel. For purposes of explanation of the subject technology, the process 900 will be discussed in reference to one or more of the figures above.

At step 902, a first camera object for rendering a first image of an area in the shared artificial reality environment at a first angle may be created. According to an aspect, creating the first camera object comprises creating a first stereoscopic camera object for generating computer graphics from a perspective of a left eye of the user representation. At step 904, a second camera object for rendering a second image of the area at a second angle may be created. According to an aspect, creating the second camera object comprises creating a second stereoscopic camera object for generating computer graphics from a perspective of a right eye of the user representation. At step 906, a combination of the first image and the second image for an optical viewpoint for a user representation in the shared artificial reality environment may be routed. According to an aspect, routing the combination of the first image and the second image comprises creating a three-dimensional effect for the virtual effect. For example, the virtual object comprises at least one of: a virtual screen, a virtual thumbnail, a virtual still image, a virtual decoration, a virtual user interface, a virtual portal, a virtual icon, a virtual card, a virtual window, a virtual wallpaper, or a virtual cover.

At step 908, a stereoscopic texture based on the combination of the first image and the second image may be generated. According to an aspect, generating the stereoscopic texture comprises rendering a texture for a virtual surface and determining a focal length and an interaxial separation for the optical viewpoint. At step 910, the stereoscopic texture to a virtual element in the area may be applied via a shader. According to an aspect, applying stereoscopic texture to the virtual element comprises applying an offset for the optical viewpoint and another optical viewpoint. As an example, the optical viewpoint corresponds to a left eye of the user representation and the another optical viewpoint corresponds to a right eye of the user representation. According to an aspect, applying stereoscopic texture to the virtual element comprises determining a camera tilt to converge the optical viewpoint and the another viewpoint. According to an aspect, applying stereoscopic texture to the virtual element comprises creating a render texture for a surface for the virtual element based on an aspect ratio and applying the shader to the surface based on the render texture for assigning portions of the surface to the optical viewpoint.

According to an aspect, the process 900 may further include determining a maximum parallax value based on a surface size and a view distance for the user representation. According to an aspect, the process 900 may further include applying stereo instancing via the shader and determining a quantity of sub-cameras for the first camera object and the second camera object. According to an aspect, the process 900 may further include determining a zero parallax surface based on a first projection and a second projection of the optical viewpoint. According to an aspect, the process 900 may further include adjusting a value of the zero parallax surface for changing a type of three-dimensional effect for the virtual element.

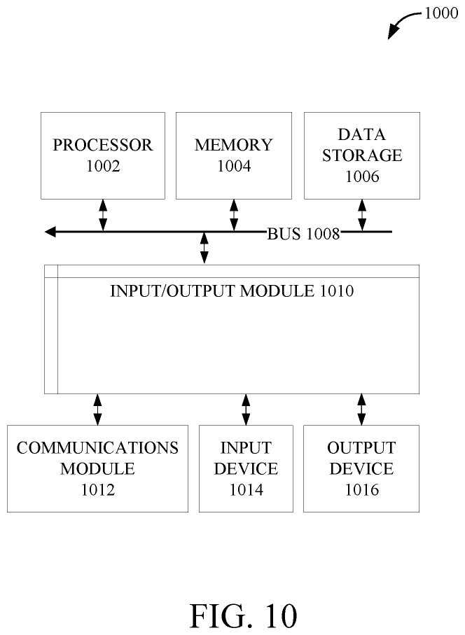

FIG. 10 is a block diagram illustrating an exemplary computer system 1000 with which aspects of the subject technology can be implemented. In certain aspects, the computer system 1000 may be implemented using hardware or a combination of software and hardware, either in a dedicated server, integrated into another entity, or distributed across multiple entities.

The computer system 1000 (e.g., server and/or client) includes a bus 1008 or other communication mechanism for communicating information, and a processor 1002 coupled with the bus 1008 for processing information. By way of example, the computer system 1000 may be implemented with one or more processors 1002. Each of the one or more processors 1002 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

The computer system 1000 can include, in addition to hardware, code that creates an execution environment for the computer program in question, e.g., code that constitutes processor firmware, a protocol stack, a database management system, an operating system, or a combination of one or more of them stored in an included memory 1004, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1008 for storing information and instructions to be executed by processor 1002. The processor 1002 and the memory 1004 can be supplemented by, or incorporated in, special purpose logic circuitry.

The instructions may be stored in the memory 1004 and implemented in one or more computer program products, i.e., one or more modules of computer program instructions encoded on a computer-readable medium for execution by, or to control the operation of, the computer system 1000, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1004 may also be used for storing temporary variable or other intermediate information during execution of instructions to be executed by the processor 1002.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

The computer system 1000 further includes a data storage device 1006 such as a magnetic disk or optical disk, coupled to bus 1008 for storing information and instructions. The computer system 1000 may be coupled via input/output module 1010 to various devices. The input/output module 1010 can be any input/output module. Exemplary input/output modules 1010 include data ports such as USB ports. The input/output module 1010 is configured to connect to a communications module 1012. Exemplary communications modules 1012 include networking interface cards, such as Ethernet cards and modems. In certain aspects, the input/output module 1010 is configured to connect to a plurality of devices, such as an input device 1014 and/or an output device 1016. Exemplary input devices 1014 include a keyboard and a pointing device, e.g., a mouse or a trackball, by which a user can provide input to the computer system 1000. Other kinds of input devices can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1016 include display devices such as an LCD (liquid crystal display) monitor, for displaying information to the user.

According to one aspect of the present disclosure, the above-described systems can be implemented using a computer system 1000 in response to the processor 1002 executing one or more sequences of one or more instructions contained in the memory 1004. Such instructions may be read into memory 1004 from another machine-readable medium, such as data storage device 1006. Execution of the sequences of instructions contained in the main memory 1004 causes the processor 1002 to perform the process steps described herein. One or more processors in a multi-processing arrangement may also be employed to execute the sequences of instructions contained in the memory 1004. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

The computer system 1000 can include clients and servers. A client and server are generally remote from each other and typically interact through a communication network. The relationship of client and server arises by virtue of computer programs running on the respective computers and having a client-server relationship to each other. The computer system 1000 can be, for example, and without limitation, a desktop computer, laptop computer, or tablet computer. The computer system 1000 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to the processor 1002 for execution. Such a medium may take many forms, including, but not limited to, non-volatile media, volatile media, and transmission media. Non-volatile media include, for example, optical or magnetic disks, such as the data storage device 1006. Volatile media include dynamic memory, such as the memory 1004. Transmission media include coaxial cables, copper wire, and fiber optics, including the wires that comprise the bus 1008. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 1000 reads XR data and provides an artificial reality, information may be read from the XR data and stored in a memory device, such as the memory 1004. Additionally, data from the memory 1004 servers accessed via a network, the bus 1008, or the data storage 1006 may be read and loaded into the memory 1004. Although data is described as being found in the memory 1004, it will be understood that data does not have to be stored in the memory 1004 and may be stored in other memory accessible to the processor 1002 or distributed among several media, such as the data storage 1006.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for stereoscopic features in a shared artificial reality environment, the method comprising:
creating a first camera object for rendering a first image of an area in the shared artificial reality environment at a first angle;
creating a second camera object for rendering a second image of the area at a second angle;
routing a combination of the first image and the second image for an optical viewpoint for a user representation in the shared artificial reality environment;
generating a stereoscopic texture based on the combination of the first image and the second image; and
applying, via a shader, the stereoscopic texture to a virtual element in the area.

2. The computer-implemented method of claim 1, wherein creating the first camera object comprises creating a first stereoscopic camera object for generating computer graphics from a perspective of a left eye of the user representation.

3. The computer-implemented method of claim 1, wherein creating the second camera object comprises creating a second stereoscopic camera object for generating computer graphics from a perspective of a right eye of the user representation.

4. The computer-implemented method of claim 1, wherein routing the combination of the first image and the second image comprises creating a three-dimensional effect for the virtual effect, wherein the virtual object comprises at least one of: a virtual screen, a virtual thumbnail, a virtual still image, a virtual decoration, a virtual user interface, a virtual portal, a virtual icon, a virtual card, a virtual window, a virtual wallpaper, or a virtual cover.

5. The computer-implemented method of claim 1, wherein generating the stereoscopic texture comprises:
rendering a texture for a virtual surface; and
determining a focal length and an interaxial separation for the optical viewpoint.

6. The computer-implemented method of claim 1, wherein applying stereoscopic texture to the virtual element comprises:
applying an offset for the optical viewpoint and another optical viewpoint, wherein the optical viewpoint corresponds to a left eye of the user representation and the another optical viewpoint corresponds to a right eye of the user representation; and
determining a camera tilt to converge the optical viewpoint and the another viewpoint.

7. The computer-implemented method of claim 1, wherein applying stereoscopic texture to the virtual element comprises:
creating a render texture for a surface for the virtual element based on an aspect ratio; and
applying the shader to the surface based on the render texture for assigning portions of the surface to the optical viewpoint.

8. The computer-implemented method of claim 1, further comprising determining a maximum parallax value based on a surface size and a view distance for the user representation.

9. The computer-implemented method of claim 1, further comprising:
applying stereo instancing via the shader; and
determining a quantity of sub-cameras for the first camera object and the second camera object.

10. The computer-implemented method of claim 1, further comprising:
determining a zero parallax surface based on a first projection and a second projection of the optical viewpoint; and
adjusting a value of the zero parallax surface for changing a type of three-dimensional effect for the virtual element.

11. A system for stereoscopic features in a shared artificial reality environment, comprising:
one or more processors; and
a memory comprising instructions stored thereon, which when executed by the one or more processors, causes the one or more processors to perform:
creating a first camera object for rendering a first image of an area in the shared artificial reality environment at a first angle;
creating a second camera object for rendering a second image of the area at a second angle;
routing a combination of the first image and the second image for an optical viewpoint for a user representation in the shared artificial reality environment;
determining a zero parallax surface based on a first projection and a second projection of the optical viewpoint;
generating a stereoscopic texture based on the combination of the first image and the second image; and
applying, via a shader, the stereoscopic texture to a virtual element in the area.

12. The system of claim 11, wherein the instructions that cause the one or more processors to perform creating the first camera object cause the one or more processors to perform creating a first stereoscopic camera object for generating computer graphics from a perspective of a left eye of the user representation.

13. The system of claim 11, wherein the instructions that cause the one or more processors to perform creating the second camera object cause the one or more processors to perform creating a second stereoscopic camera object for generating computer graphics from a perspective of a right eye of the user representation.

14. The system of claim 11, wherein the instructions that cause the one or more processors to perform routing the combination of the first image and the second image cause the one or more processors to perform creating a three-dimensional effect for the virtual effect, wherein the virtual object comprises at least one of: a virtual screen, a virtual thumbnail, a virtual still image, a virtual decoration, a virtual user interface, a virtual portal, a virtual icon, a virtual card, a virtual window, a virtual wallpaper, or a virtual cover.

15. The system of claim 11, wherein the instructions that cause the one or more processors to perform generating the stereoscopic texture cause the one or more processors to perform:
rendering a texture for a virtual surface; and
determining a focal length and an interaxial separation for the optical viewpoint.

16. The system of claim 11, wherein the instructions that cause the one or more processors to perform applying stereoscopic texture to the virtual element cause the one or more processors to perform:
applying an offset for the optical viewpoint and another optical viewpoint, wherein the optical viewpoint corresponds to a left eye of the user representation and the another optical viewpoint corresponds to a right eye of the user representation; and
determining a camera tilt to converge the optical viewpoint and the another viewpoint.

17. The system of claim 11, wherein the instructions that cause the one or more processors to perform applying stereoscopic texture to the virtual element cause the one or more processors to perform:
creating a render texture for a surface for the virtual element based on an aspect ratio; and
applying the shader to the surface based on the render texture for assigning portions of the surface to the optical viewpoint.

18. The system of claim 11, further comprising stored sequences of instructions, which when executed by the one or more processors, cause the one or more processors to perform:
applying stereo instancing via the shader; and
determining a quantity of sub-cameras for the first camera object and the second camera object.

19. The system of claim 11, further comprising stored sequences of instructions, which when executed by the one or more processors, cause the one or more processors to perform:
determining a maximum parallax value based on a surface size and a view distance for the user representation; and
adjusting a value of the zero parallax surface for changing a type of three-dimensional effect for the virtual element.

20. A non-transitory computer-readable storage medium comprising instructions stored thereon, which when executed by one or more processors, cause the one or more processors to perform operations for stereoscopic features in a shared artificial reality environment, comprising:
creating a first camera object for rendering a first image of an area in the shared artificial reality environment at a first angle;
creating a second camera object for rendering a second image of the area at a second angle;
routing a combination of the first image and the second image for an optical viewpoint for a user representation in the shared artificial reality environment;
determining a zero parallax surface based on a first projection and a second projection of the optical viewpoint;
generating a stereoscopic texture based on the combination of the first image and the second image;
applying, via a shader, the stereoscopic texture to a virtual element in the area; and
adjusting a value of the zero parallax surface for changing a type of three-dimensional effect for the virtual element.
